(19) United States
(12) Patent Application Publication
(10) Pub. No.: US 2026/0349137 A1
(43) Pub. Date: Nov. 5, 2026

(54) ORIENTATION-GATED GRAVITATIONAL INTERACTION MODULATOR WITH ILG TIME- KERNEL TUNING AND OPTIONAL EIGHT-TICK PHASE GATING

(71) Applicant: Jonathan Washburn, Austin, TX (US)

(72) Inventor: Jonathan Washburn, Austin, TX (US)

(21) Appl. No.: 19/667,881

(22) Filed: May 5, 2026

Related U.S. Application Data
(60) Provisional application No. 63/800,225, filed on May 5, 2025.

(51) Int. Cl. G01V 7/02

(52) U.S. Cl. CPC G01V 7/02

(57) ABSTRACT

A method, apparatus, and system for modulating effective gravitational coupling between a device and a gravitational source are disclosed. The modulation architecture controls (i) an effective interaction-channel orientation relative to a local gravitational gradient, (ii) an effective dynamical timescale that sets an information-limited gravity time-kernel weight, and, in preferred implementations, (iii) an eight-tick phase-gating schedule. In representative forms, the orientation-dependent coupling weight follows sin^2(theta), and the time-kernel weight varies with T_dyn relative to a reference tick tau_0. The architecture may be implemented using rotating phi-spiral structures, phased virtual rotors, orientation-controlled cavity arrays, superconducting platforms, or analogous structures. A sensing subsystem detects resulting changes in gravitational force, acceleration, or equivalent coupling response on a test mass or other measurement target.

### CROSS-REFERENCE TO RELATED APPLICATIONS

This application claims the benefit of and priority to U.S. Provisional Patent Application No. 63/800,225, filed on May 5, 2025, and titled “Orientation-Gated Gravitational Interaction Modulator Based on Golden-Ratio Recognition Lattices,” the entirety of which is hereby incorporated by reference herein.

### BACKGROUND

This invention relates generally to gravitational interaction control and precision gravimetry, and more particularly to methods, apparatus, and systems for modulating effective gravitational coupling by controlling geometric orientation relative to a local gravitational gradient, tuning an information-limited gravity time-kernel through control of an effective dynamical timescale, and, in preferred implementations, applying eight-tick phase gating to gravitational recognition events.

Gravitational interaction modulation has long been a subject of theoretical and experimental interest. Various workers have proposed or reported anomalous gravitational effects in connection with rotating superconductors, accelerated structures, and other specialized systems. However, prior efforts have generally lacked a complete operating architecture that identifies which device variables are to be controlled, how such variables are related to gravitational coupling, and how a resulting effect is to be measured, validated, or falsified.

By way of example, prior rotating-superconductor reports have asserted apparent weight reductions or related anomalies above or near rotating cryogenic disks. Other proposals have suggested gravitomagnetic amplification, Cooper-pair alignment effects, or generalized gravitational shielding. Still other disclosures have advanced broad claims of gravity modification without providing a concrete mechanism tying device geometry, internal dynamics, and measurement architecture to a predicted modulation of gravitational response.

These prior approaches suffer from multiple limitations. First, they do not provide a disclosed first-principles framework that identifies a specific controllable mechanism by which effective gravitational coupling is changed. Second, they do not specify exact geometric conditions under which coupling is enhanced, suppressed, or otherwise modulated. Third, they do not specify exact temporal, dynamical, or phase conditions under which such modulation is expected to occur. Fourth, they do not provide a disciplined architecture that separates a core modulation mechanism from optional embodiments, downstream applications, and future research directions.

In addition, prior approaches generally fail to provide a coherent make-and-use disclosure for a gravitational modulation system. For example, they often do not identify the relevant inputs, outputs, control variables, workflow stages, synchronization requirements, measurement protocols, validation paths, or acceptance criteria needed to distinguish a true coupling modulation from vibration, thermal artifacts, electromagnetic interference, environmental drift, or other non-gravitational effects.

A further limitation of prior work is the absence of a prosecution-ready disclosure structure. Existing approaches often do not preserve a clear distinction between a broad independent method concept, narrower fallback positions, embodiment-specific apparatus concepts, measurement and controller implementations, and downstream commercial or scientific uses. As a result, such disclosures can become vulnerable to core drift, overbreadth, or enablement challenges.

In the disclosed framework of the present invention, gravity is treated not as a generic force-control target but as a phenomenon that can be modulated through a specific architecture involving orientation-dependent interaction weighting and time-kernel-dependent dynamical weighting. This enables a more disciplined and testable design approach than prior proposals that merely posit anomalous effects without identifying the operative control variables.

More specifically, a need remains for a gravitational interaction modulation architecture that identifies controllable variables governing effective gravitational coupling, provides concrete implementations for controlling those variables, enables measurable modulation of gravitational force, acceleration, or equivalent coupling response, supports synchronization and calibration, and preserves explicit falsification criteria capable of distinguishing true modulation from artifact.

A need also remains for a disclosure that is broad enough to preserve flexibility across multiple implementation platforms, including rotating structures, field-steered virtual rotors, cavity-based orientation arrays, and superconducting implementations, while remaining disciplined enough to preserve a clear and defensible statement of the actual core invention.

The present invention addresses these and other needs by providing a specific gravitational interaction modulation architecture in which effective coupling is modulated through coordinated control of interaction-channel orientation relative to a local gravitational gradient, control of an effective dynamical timescale associated with an information-limited gravity time-kernel, and, in preferred forms, control of permitted interaction timing through an eight-tick phase-gating framework.

### SUMMARY

The present invention provides a method, apparatus, and system for modulating effective gravitational coupling by controlling three disclosed mechanisms that can operate together: orientation gating of an effective interaction channel relative to a local gravitational gradient, time-kernel tuning through control of an effective dynamical timescale, and, in preferred implementations, eight-tick phase gating of permitted gravitational recognition events.

In one aspect, the invention provides a method of modulating effective gravitational coupling between a device and a gravitational source by providing a device having at least one effective interaction channel characterized by an effective angle relative to a local gravitational gradient, controlling said effective angle to vary an orientation-dependent coupling weight, controlling an effective dynamical timescale of the device to vary a time-kernel-dependent weighting term, and measuring a resulting change in gravitational force, acceleration, or equivalent coupling response on a test mass or other measurement target.

In another aspect, the invention provides a gravitational interaction modulator comprising an orientation-control structure configured to define or vary an effective interaction-channel angle relative to a local gravitational gradient, a timescale-control structure configured to set or vary an effective dynamical timescale of the modulator, and a measurement structure configured to detect a corresponding modulation in effective gravitational coupling. In preferred forms, the modulator further comprises a phase-control structure configured to gate interaction events according to an eight-tick cadence.

In a further aspect, the invention provides a system comprising a gravitational interaction modulator, a controller configured to coordinate angle control and timescale control, and a sensing subsystem configured to extract a gravitational modulation signal from one or more measured outputs. In certain preferred implementations, the system further comprises synchronization logic, calibration structures, artifact-rejection structures, environmental controls, and data-acquisition logic.

The disclosed operating basis of the invention treats gravity as a coherence defect arising from a gradient-dependent mismatch across an extended object. Within that disclosed framework, free fall corresponds to the unique acceleration that restores zero coherence defect. The invention uses this disclosed operating basis to justify modulation of apparent gravitational coupling through controlled changes in effective weighting of gravitational interaction channels and controlled changes in the relevant dynamical timescale.

In preferred forms, the effective gravitational weight is governed by an information-limited gravity time-kernel of the form:

w_t(T_dyn, tau_0)=1+C_lag×((T_dyn/tau_0)^alpha_t−1)

where T_dyn is an effective dynamical timescale of the device, tau_0 is a recognition tick, C_lag is a lag-coupling term, and alpha_t is a dynamical-time exponent. In disclosed theory-supported implementations, C_lag is phi^−5 and alpha_t is (1-1/phi)/2, where phi is the golden ratio.

In preferred forms, the orientation-dependent interaction weighting follows:

w_orient(theta)=sin^2(theta)

where theta is an effective angle between the relevant interaction channel and the local gravitational gradient. As a result, channels aligned toward a suppressed-coupling orientation contribute less to effective gravitational coupling, while channels aligned toward a full-coupling orientation contribute more strongly.

In representative implementations, the effective gravitational coupling can be expressed as:

g_eff=g_0×w_t(T_dyn)×w_orient(theta)×w_phase

where g_0 is a base gravitational coupling term and w_phase is a phase-gating term that may be equal to one during permitted phase windows and reduced or zero outside such windows, or may otherwise represent phase-selective weighting or duty-cycle weighting.

The disclosed architecture supports multiple operating modes. In one operating mode, effective gravitational coupling is enhanced by selecting a relatively large effective dynamical timescale and a relatively strong-coupling channel orientation. In another operating mode, effective gravitational coupling is suppressed by selecting a relatively small effective dynamical timescale and a relatively weak-coupling channel orientation. In a further operating mode, effective gravitational coupling is modulated periodically or quasi-periodically by varying one or both of angle and timescale over time, optionally under phase-gated control.

The invention is not limited to a single physical platform. In various preferred embodiments, the disclosed angle-control and timescale-control architecture is implemented using a rotating phi-spiral structure, a phased-array virtual rotor, an orientation-controlled cavity array, a superconducting rotating disk, or another analogous structure that concretely realizes the disclosed interaction-angle and dynamical-timescale control variables.

In certain embodiments, the invention employs a rotating physical structure such that the effective dynamical timescale is set by a rotation period and the effective interaction-channel angle varies as a function of angular position. In other embodiments, the invention employs a field-steered virtual rotor in which a phased sequence of electromagnetic or other actuation events produces an effective rotating interaction pattern without continuous mechanical rotation. In further embodiments, the invention employs an array of individually orientable structures, such as cavity elements, each contributing a selectable interaction-channel angle to a net effective coupling.

In preferred measurement implementations, a modulation signal is extracted using synchronized detection, including lock-in detection at a modulation frequency associated with angle variation, phase gating, or an effective rotational sequence. Such synchronized measurement improves discrimination between a true coupling modulation and environmental artifacts including vibration, thermal drift, electromagnetic interference, and background force noise.

In some implementations, the controller is configured to initialize the system, calibrate one or more measurement channels, set a target operating mode, actuate angle control and timescale control, apply a phase schedule where used, collect measured force data, extract a modulation signal, and compare the measured signal to one or more acceptance criteria. In some embodiments, the controller may further perform null measurements, background subtraction, angle sweeps, timescale sweeps, material comparisons, or vacuum-persistence checks.

In certain forms, the invention also provides validation and falsification workflows. Such workflows may include verifying the existence of an orientation dependence, verifying a predicted relationship between modulation and the effective dynamical timescale, verifying persistence under vacuum and thermal controls, verifying absence of material dependence within a selected operating regime, and distinguishing between alternative kernel-scaling models.

In some embodiments, the disclosed system is used for precision gravimetry, inertial sensing, gravitational-model validation, or other downstream applications. However, such downstream applications do not define the core invention. The core invention remains the disclosed architecture for modulating effective gravitational coupling through coordinated control of interaction-channel orientation and effective dynamical timescale, optionally further coordinated with eight-tick phase gating.

In certain implementations, the disclosure is further supported by formal verification artifacts, including machine-checked support for coherence-defect relations, free-fall restoration, time-kernel properties, and associated gravitational parameter relations. Such formal support may strengthen the disclosed architecture and provide narrower fallback positions, while not limiting the invention to any specific proof environment.

Additional features, implementations, refinements, controller structures, measurement workflows, figure embodiments, and claim variations will be apparent from the following description, drawings, and claims.

### BRIEF DESCRIPTION OF THE DRAWINGS

FIG. 1 is a schematic diagram illustrating gravity as a coherence defect across an extended object disposed in a local gravitational gradient, and further illustrating a unique free-fall condition that restores zero coherence defect.

FIG. 2 is a schematic diagram illustrating orientation gating geometry, including an effective interaction channel disposed at an effective angle relative to a local gravitational gradient, and further illustrating an orientation-dependent coupling weight.

FIG. 3 is a block and schematic diagram illustrating a combined modulation architecture in which orientation control, time-kernel tuning, and optional phase gating cooperate to produce an effective gravitational coupling output acting on a measurement target.

FIG. 4 is a graphical representation illustrating a time-kernel weighting term as a function of an effective dynamical timescale relative to a reference tick, including representative operating regimes and alternative scenario behaviors.

FIG. 5 is a schematic plan or perspective view of a physical phi-spiral rotor embodiment configured to provide angle variation and dynamical-timescale control through rotation.

FIG. 6 is a schematic diagram of a virtual rotor phased-array embodiment in which a sequenced field pattern generates an effective rotating interaction structure without requiring continuous physical rotation.

FIG. 7 is a schematic diagram of an orientation-controlled cavity-array embodiment in which multiple cavity elements are individually or collectively oriented to define a selected interaction-angle distribution.

FIG. 8 is a schematic diagram of a superconducting disk embodiment including a rotating superconducting structure, associated environmental controls, and a measurement arrangement for detecting coupling modulation.

FIG. 9 is a block and schematic diagram of a measurement and sensing architecture, including a test mass, a force sensor, synchronized extraction circuitry, and associated data-acquisition components.

FIG. 10 is a block diagram of a controller and feedback architecture including angle-control logic, timescale-control logic, optional phase-control logic, sensor inputs, actuator outputs, and result logging or storage functions.

FIG. 11 is a workflow diagram illustrating validation and falsification procedures, including one or more of angle sweeps, timescale sweeps, material comparisons, environmental persistence checks, and model-fit classification steps.

FIG. 12 is a system-level diagram of an integrated modulation platform including a modulator, sensing subsystem, controller subsystem, calibration subsystem, shielding or environmental structures, and an output or analysis interface.

### DETAILED DESCRIPTION

The following detailed description sets forth representative embodiments, operating principles, workflows, structures, and variations of the presently disclosed gravitational interaction modulation architecture. The description is provided to enable one of ordinary skill in the art to make and use the invention and to support a range of claim scopes, including broad architecture claims, narrower fallback claims, system claims, embodiment-specific claims, controller claims, validation claims, and downstream use claims. Unless expressly stated otherwise, no embodiment, material selection, dimension, operating value, or implementation detail described herein is required in all implementations.

The core invention is a gravitational interaction modulation architecture that modulates effective gravitational coupling by coordinated control of two load-bearing variables and, in preferred implementations, a third timing variable. The first load-bearing variable is an effective interaction-channel orientation relative to a local gravitational gradient. The second load-bearing variable is an effective dynamical timescale associated with a time-kernel weighting relation. The preferred third variable is a phase-selection or phase-gating relation associated with an eight-tick cadence. The invention is therefore not directed to generic gravity control, generic force modification, or generic field manipulation, but to a specific architecture for changing apparent gravitational coupling by coordinated control of angle, timescale, and, in preferred implementations, phase.

Unlike prior proposals that broadly assert anomalous gravitational effects or generalized shielding without identifying operative control variables, synchronization structure, and validation architecture, the present disclosure identifies a specific modulation architecture centered on effective interaction-angle control, effective dynamical-timescale control, and, in preferred forms, eight-tick phase control, together with concrete sensing, calibration, and falsification pathways. This distinction is important because it frames the invention as a real machine-and-system architecture rather than a mere statement that gravity modification might occur.

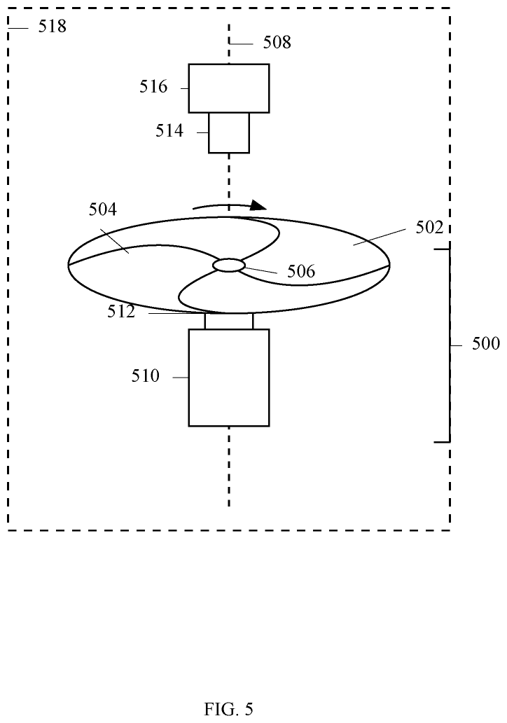

The embodiment families of FIG. 5-8 are disclosed as species implementations of the same core architecture. Unless expressly claimed, the invention is not limited to a particular species; the load-bearing inventive concept is coordinated control of effective interaction angle and effective dynamical timescale (optionally phase gating), together with synchronized measurement.

In the disclosed operating framework, gravity is treated as a coherence defect rather than as a mere undifferentiated force target. More specifically, when an extended object is disposed in a local gravitational gradient, different portions of the object experience different effective processing conditions across the extent of the object. This gradient-dependent mismatch produces a coherence defect. Within this framework, free fall corresponds to the unique acceleration that restores zero coherence defect. The present invention exploits this disclosed operating basis by selectively changing effective participation in the gravitational interaction through orientation-dependent weighting and timescale-dependent weighting, thereby modulating apparent gravitational coupling in a measurable manner.

For purposes of the present disclosure, a “gravitational source” may include any body, field region, effective source distribution, source-mass arrangement, or equivalent structure giving rise to a measurable local gravitational gradient. A “local gravitational gradient” may include a local vertical gradient, a component of gravitational acceleration, a spatial derivative of a gravitational potential, or any equivalent parameter characterizing local gravitational variation over the extent of a device, element, test mass, or interaction region.

For purposes of the present disclosure, an “interaction channel” or “recognition channel” may include any physical, geometric, modal, distributed, or effective structure through which the device couples to the local gravitational gradient under the disclosed modulation architecture. An interaction channel may be defined by a physical element axis, a structural normal, a cavity axis, a field-defined axis, a motion-defined axis, a composite array axis, an internal mode axis, or another analogous quantity that can be related to an effective angle relative to the local gravitational gradient.

An “effective angle,” as used herein, refers to an angle characterizing the relationship between a relevant interaction channel and the local gravitational gradient. In some embodiments, the effective angle corresponds to a literal geometric angle between a device element and vertical. In some embodiments, the effective angle corresponds to an internal mode orientation, a field-defined direction, or a motion-induced effective axis. In some embodiments, the effective angle is determined from a plurality of channel contributions, such as by weighted averaging, vector combination, channel summation, or another aggregation process. Accordingly, the invention is not limited to rigid-body orientation alone, provided that the disclosed effective angle remains concretely tied to a disclosed interaction structure.

A “dynamical timescale” or “effective dynamical timescale,” as used herein, refers to a characteristic timescale governing the time-kernel contribution to effective gravitational coupling. Depending on embodiment, the effective dynamical timescale may be set by a rotation period, a pulse repetition interval, a field sequencing interval, an oscillation period, a modulation envelope period, a duty-cycle timescale, or another analogous parameter governing device dynamics. In some embodiments, the timescale is a directly commanded quantity. In some embodiments, the timescale is an inferred or derived quantity from another controlled operating parameter, such as angular speed.

A “recognition tick” or “tau_0,” as used herein, refers to a reference tick or reference timescale used in the disclosed time-kernel framework. In theory-supported implementations described herein, tau_0 serves as the reference quantity against which the effective dynamical timescale T_dyn is normalized. The exact physical interpretation, calibration seam, or reporting convention associated with tau_0 may vary by implementation, but the present invention is not limited to any single reporting system so long as the disclosed timescale weighting relation is preserved.

A “phase gate,” “phase-gating relation,” or “eight-tick phase gate,” as used herein, refers to any temporal selection logic that allows, weights, emphasizes, or suppresses gravitational interaction events or interaction-channel participation according to phase location within a selected cadence. In preferred implementations, the cadence is an eight-tick cadence and the phase gate distinguishes permitted windows from non-permitted windows. In some embodiments, the phase gate is binary. In some embodiments, the phase gate is weighted. In some embodiments, the phase gate is implemented as a duty-cycle gate, a synchronization window, a pulse mask, a phase-index lookup, or another phase-selective timing structure.

A “test mass” or “measurement target,” as used herein, refers to any body, sensor-coupled element, suspended mass, proof mass, force-sensing structure, or analogous component through which a resulting change in effective gravitational coupling is detected. In some embodiments, the test mass is a mechanically distinct body positioned adjacent a modulator. In some embodiments, the measurement target is integrated into the modulator assembly. In some embodiments, the measurement target is a field-coupled, cavity-coupled, suspended, torsional, cryogenic, or cantilever-supported body.

The disclosed operating basis can be summarized by treating an extended object as experiencing a gradient-dependent mismatch across its extent. In representative formulations, a coherence defect D(a) in a frame accelerating at acceleration a may be expressed as:

D(a)=|2 epsilon×(dPhi/dh+a)|

where epsilon represents an effective half-extent or characteristic extent of the object, dPhi/dh represents a local gravitational-potential gradient, and a represents frame acceleration or an equivalent acceleration term. The total potential experienced in the accelerating frame may be described as a sum of a gravitational component and an acceleration-associated component. Within that framework, there exists a unique acceleration a* at which the coherence defect is zero.

This disclosed free-fall restoration condition provides the conceptual basis for the invention. If apparent weight corresponds to sustaining a non-zero coherence defect, then apparent gravitational coupling can be changed by changing how the device participates in the relevant interaction. The present invention does not require direct modification of an ambient gravitational field in the conventional sense. Instead, the invention modulates effective coupling by changing interaction weighting through one or more of orientation gating, dynamical-timescale weighting, and phase-gating selection.

In theory-supported implementations, the disclosed modulation architecture is not merely an arbitrary control scheme, but is grounded in a specific coherence-defect and recognition-operator framework in which gravity is treated as a mismatch-driven interaction condition and free fall is the unique zero-defect state. Within that framework, the disclosed control variables—effective interaction angle, effective dynamical timescale, and, in preferred forms, eight-tick phase selection—are not selected ad hoc, but arise as the operative variables governing modulation of apparent gravitational coupling. The present claims, however, remain directed to the machine, method, and system architecture disclosed herein rather than to the broader theory in the abstract.

In preferred forms, the effective gravitational weight is governed by an information-limited gravity time-kernel of the form: w_t(T_dyn, tau_0)=1+C_lag×((T_dyn/tau_0)^alpha_t−1) where w_t is a time-kernel weighting term, T_dyn is an effective dynamical timescale of the device, tau_0 is a reference recognition tick, C_lag is a lag-coupling coefficient, and alpha_t is a dynamical-time exponent. In theory-supported forms described herein, C_lag is phi^−5 and alpha_t is (1-1/phi)/2. In broader architectural forms, the invention may still be practiced with a functionally equivalent time-kernel weighting relation that depends on effective dynamical timescale, provided that the disclosure is relied upon for the claimed scope.

Several properties of the disclosed time-kernel are strategically important. First, when T_dyn equals tau_0, the kernel equals unity, thereby defining a reference condition. Second, the kernel is scale-consistent in the sense that corresponding proportional rescalings of T_dyn and tau_0 preserve the normalized relation. Third, the kernel remains nonnegative. Fourth, in theory-supported forms, the kernel is greater than or equal to unity when T_dyn is greater than or equal to tau_0. These properties support enhancement-mode operation, reference-mode operation, and comparative measurement protocols.

In theory-supported implementations, the time-kernel relation is not merely heuristic but is supported by a defined parameter structure in which C_lag=phi^−5 and alpha_t=(1-1/phi)/2. In such implementations, phi denotes the golden ratio, C_lag represents a recognition-lag coupling term, and alpha_t represents a dynamical-time exponent governing scaling of the effective weighting with normalized dynamical timescale.

In theory-supported implementations, the time-kernel further satisfies the following properties: first, w_t(tau_0, tau_0)=1, thereby defining a reference condition at the recognition scale; second, the kernel is scale-consistent such that corresponding proportional rescalings of T_dyn and tau_0 preserve the normalized weighting relation; third, the kernel is nonnegative; and fourth, the kernel is greater than or equal to unity when T_dyn is greater than or equal to tau_0. These properties support reference-mode operation, enhancement-mode operation, comparative measurement protocols, and multi-regime validation procedures.

In further theory-supported forms, a gravity-parameter framework associated with the disclosed modulation architecture is derived from phi. Representative parameters include alpha_gravity, upsilon_star, C_xi, p, A, and coupled parameters a_0 and r_0. Such parameter relations provide support for narrower fallback claim positions, theory-tethered embodiments, and validation workflows, while the broadest architectural claims remain directed to the disclosed modulation of effective gravitational coupling through control of angle and effective dynamical timescale.

In representative theory-supported implementations, phi is approximately 1.6180339887, C_lag=phi^−5 is approximately 0.0902, alpha_t=(1-1/phi)/2 is approximately 0.191, and tau_0 is approximately 7.3×10^−15 seconds under a selected reporting convention. Representative gravity parameters associated with the disclosed framework include alpha_gravity=1-1/phi, upsilon_star=phi, C_xi=2phi^−4, p=1-alpha_t/4, A=1+alpha_t/2, and coupled parameters a_0 and r_0 linked through a characteristic timescale relation. These representative values are included to preserve exact disclosed theory support, narrower fallback positions, and implementation context, while the broadest architectural aspects of the invention remain directed to modulation of effective gravitational coupling through control of effective interaction angle and effective dynamical timescale.

In practice, the effective dynamical timescale may be controlled in a variety of concrete ways. In a rotating embodiment, the effective dynamical timescale may be set by a rotation period or a related periodic interval. In a pulsed embodiment, the effective dynamical timescale may be set by a pulse repetition rate, sequence cycle duration, or effective field-rotation period. In an oscillatory embodiment, the effective dynamical timescale may be set by an oscillation period. In a controller-driven embodiment, the effective dynamical timescale may be computed from one or more control parameters and then refined in closed loop based on measured output.

The orientation-dependent weighting is preferably governed by the relation: w_orient(theta)=sin^2(theta) where theta is the effective angle between the relevant interaction channel and the local gravitational gradient. Under this disclosed relation, channels near a suppressed-coupling orientation contribute weakly, and channels near a full-coupling orientation contribute strongly. The present invention uses this angle-dependent weighting as a direct control lever for effective gravitational coupling.

In some embodiments, the effective angle theta is set by physically rotating a structure relative to local vertical. In some embodiments, theta is set by rotating or steering an internal mode axis without requiring bulk rotation of the overall assembly. In some embodiments, theta is set by sequencing field-producing elements such that the effective interaction axis rotates or precesses in time. In some embodiments, theta is determined across a plurality of elements, each having its own individual orientation, such that total effective coupling is computed from a sum, weighted sum, average, or another aggregate of individual channel contributions.

The invention therefore supports both single-channel and multi-channel implementations. In a single-channel implementation, one channel has one effective angle theta and one effective timescale T_dyn at any given operating state. In a multi-channel implementation, multiple channels may have different angles, different temporal states, or different weighting factors, with the net effective coupling determined from the combined contribution of the channels. Such channels may be spatially distributed, time-multiplexed, structurally distinct, field-defined, or otherwise concretely implemented.

In preferred embodiments, the invention further employs an eight-tick phase-gating structure. The phase-gating structure may be used to permit interaction events only during selected phase windows, to suppress events during non-selected windows, or to apply different relative weights to different phase positions within an eight-tick cycle. The eight-tick phase-gating relation adds temporal selectivity and can improve signal discrimination, synchronization, and control over enhancement, suppression, or oscillatory modulation modes.

Although the broadest implementations may be practiced using angle control and timescale control without requiring every preferred timing layer, the eight-tick phase-gating structure is a central preferred feature of the disclosed architecture. In particular, orientation gating, time-kernel tuning, and eight-tick phase gating are disclosed as three mechanisms capable of working in concert to produce enhancement, suppression, and oscillatory modulation modes with improved temporal selectivity and improved measurement discrimination.

In certain theory-supported implementations, orientation gating may include a weak-coupling or sub-threshold angular region in which interaction channels below a selected effective angle contribute negligibly, below a selected threshold, or at a substantially reduced level to effective gravitational coupling. In some such implementations, the weak-coupling region may be characterized by an effective-angle threshold, an action-budget threshold, a duty-factor threshold, or another selected coupling threshold. This weak-coupling-region formulation is a preferred fallback description of the disclosed orientation-gating architecture and may be used in addition to, and not in place of, the preferred sin squared angular weighting relation set forth herein.

In some embodiments, the phase gate is binary, such that w_phase equals one in permitted windows and zero in non-permitted windows. In some embodiments, the phase gate is fractional or weighted, such that different windows contribute with different magnitudes. In some embodiments, the phase gate acts as a duty-cycle factor. In some embodiments, the phase gate is synchronized to rotation angle, pulse sequence position, cavity orientation schedule, or measurement timing. In some embodiments, the phase gate is implemented in firmware, software, or hardware timing circuitry.

In representative implementations, the effective gravitational coupling can be described as: g_eff=g_0×w_t(T_dyn)×w_orient(theta)×w_phase where g_0 is a base gravitational coupling term, w_t is the time-kernel weight, w_orient is the orientation weight, and w_phase is a phase-gating or phase-selection term. This expression is illustrative and may be modified to incorporate sums over channels, duty-cycle averaging, staged weighting, or effective aggregated variables, while preserving the core architecture of angle control plus timescale control and, in preferred forms, phase gating.

The disclosed architecture supports several operating modes. In an enhancement mode, the system is operated so that the effective timescale weighting is relatively large and the interaction-channel orientation is biased toward a strong-coupling configuration. In a suppression mode, the system is operated so that the effective timescale weighting is reduced or near a reference state while the interaction-channel orientation is biased toward a weak-coupling configuration. In an oscillatory mode, one or both of the angle and timescale variables are changed periodically, quasi-periodically, or according to a programmed schedule, such that the effective coupling varies over time and produces a detectable modulation signal.

In some implementations, one variable is held substantially constant while another variable is swept or modulated. For example, an orientation sweep may be carried out while the effective dynamical timescale is held fixed. In other implementations, the effective angle is held fixed while the timescale is swept. In still other implementations, both variables are jointly varied under an optimization schedule or lookup table. Such flexibility is useful for calibration, validation, sensitivity maximization, background rejection, or distinguishing among alternative theoretical or empirical scaling behaviors.

The invention is not limited to a single hardware family. In one preferred family of embodiments, the invention is implemented using a rotating structure having a phi-spiral or other angle-varying surface geometry. In another preferred family of embodiments, the invention is implemented using a phased array that produces a virtual rotating interaction structure without requiring continuous mechanical motion. In another preferred family of embodiments, the invention is implemented using a cavity array or comparable distributed structure in which channel orientation is controlled element-by-element. In another preferred family of embodiments, the invention is implemented using a superconducting rotating disk or comparable cryogenic platform. In each case, the same core architecture is preserved: effective angle control, effective timescale control, and, optionally, phase gating.

In one preferred rotating embodiment, a rotor is configured so that rotation both defines an effective dynamical timescale and causes the effective interaction-channel orientation at a selected measurement location to vary with angular position. In a particularly preferred form, the rotor includes a phi-spiral geometry or a comparable patterned geometry capable of producing a repeatable angle-varying interaction profile as the rotor turns. The rotor may be supported by conventional bearings, magnetic bearings, air bearings, cryogenic supports, or other low-artifact support structures.

In one preferred virtual rotor embodiment, an array of coils, electrodes, field emitters, or other actuation elements is driven in sequence so as to create an effective rotating interaction axis or rotating field-defined channel without requiring a massive rotating body. In such embodiments, the effective dynamical timescale may be set by the sequence repetition rate, effective rotation period, or another schedule parameter. The effective angle may be determined by the instantaneous virtual channel orientation created by the sequence.

In one preferred cavity-array embodiment, a plurality of cavities or analogous structured cells are mounted on stages or supports allowing individual or collective control of orientation relative to the local gravitational gradient. Each cavity may provide one or more interaction channels. The aggregate effective coupling may then be set by the distribution of cavity angles, the number of participating cavities, the timing of cavity-angle changes, and the measurement schedule.

In one preferred superconducting embodiment, a superconducting structure, such as a disk, patterned plate, or other body, is rotated or otherwise dynamically driven while maintained under controlled environmental conditions. In some forms, patterned structures, including phi-spiral features or other geometric features, may be provided to shape angle-dependent interaction behavior. In such embodiments, cryogenic management, magnetic shielding, vibration suppression, and material-independence testing may be employed to distinguish any observed modulation signal from known artifacts.

The invention also includes a measurement architecture configured to detect a resulting modulation in effective gravitational coupling. In some embodiments, measurement is performed using a torsion balance. In some embodiments, measurement is performed using a SQUID-coupled sensor. In some embodiments, measurement is performed using a cantilever, optical displacement system, capacitive sensor, interferometric sensor, piezoresistive sensor, or another force-sensing or motion-sensing structure. In some embodiments, the measurement channel is synchronized to the actuation channel for lock-in extraction or equivalent coherent detection.

In preferred forms, the system includes a controller that accepts one or more inputs, such as a target angle profile, a target effective dynamical timescale, a target phase schedule, environmental conditions, and sensor signals. The controller may output one or more commands, such as a rotor speed command, pulse sequence command, angle-stage command, synchronization command, nulling command, or logging command. The controller may be implemented in hardware, firmware, software, or combinations thereof, provided that it concretely operates the disclosed modulation architecture.

In some embodiments, controller operation proceeds through a workflow that includes initialization, calibration, selection of an operating mode, actuation of angle control and timescale control, optional phase gating, data acquisition, modulation extraction, comparison against one or more acceptance criteria, and optional refinement or repetition. In some embodiments, the controller performs angle sweeps, timescale sweeps, or differential on/off comparisons. In some embodiments, the controller performs background subtraction, null-mode acquisition, artifact rejection, or environmental compensation.

The invention preferably employs explicit validation and falsification logic. For example, an observed signal may be evaluated for orientation dependence, frequency dependence, persistence under vacuum or thermal controls, material independence, and scaling with the effective dynamical timescale. In some embodiments, measured results are compared against one or more model classes, such as a constant-parameter kernel scaling model and a scale-running kernel model. This validation structure is advantageous because it provides an explicit pathway for distinguishing true coupling modulation from artifact and for distinguishing among theoretical alternatives.

Formal verification is an express support feature of the present disclosure. In representative theory-supported implementations, machine-checked modules define and verify the coherence-defect framework, the unique free-fall restoration condition, the information-limited gravity kernel, the grounding of kernel constants, the gravity-parameter framework, the virtual-rotor timing architecture, and the applied orientation-gated gravity architecture. Representative formal modules may correspond to Gravity. CoherenceFall, Gravity. ILG, Gravity. ILGDerivation, Gravity. GravityParameters, Gravity. Candidates. Podkletnov, Flight. SolidState. VirtualRotor, Flight. GravityBridge, and Applied. OrientationGatedGravity, together with associated theorem or property names such as falling_restores_coherence, coherence_defect_simplify, w_t_ref, w_t_rescale, w_t_nonneg, w_t_ge_one, w_t_formula_grounded, freefall_zero_defect, orientation_gating_viable, and active_stronger_than_idle. These formal-support structures strengthen the disclosure of the exact relations used herein, reinforce internal consistency, and preserve narrower fallback positions for claim drafting and prosecution, while not requiring that every commercial implementation employ a formal proof environment.

In some embodiments, formal machine-checked support is maintained in one or more theorem-proving environments for selected portions of the disclosed architecture. By way of non-limiting example, formal support may include modules corresponding to coherence-defect gravity, free-fall restoration, time-kernel definitions and properties, time-kernel derivation support, gravity-parameter derivation support, orientation-gated gravity structures, virtual-rotor timing coherence, and validation or candidate-testing structures.

In representative theory-supported implementations, formal modules may define one or more of a processing field, an extended object, a total potential in an accelerating frame, a coherence-defect function, an information-limited gravity kernel, a gravity-parameter set, an orientation channel, an orientation-weight relation, a gravity modulator configuration, a virtual rotor pulse-coherence structure, or a lab-scale prediction model. Such formal modules may further prove one or more of: uniqueness of a free-fall or zero-defect acceleration, closure or simplification of the coherence-defect relation, reference-scale kernel identity, scale-consistency of the kernel, nonnegativity of the kernel, monotonic or enhancement-side kernel behavior for selected regimes, grounding of the disclosed kernel constants, viability of orientation gating, or stronger-coupling versus weaker-coupling operating-state distinctions.

In one representative formal-support inventory, machine-checked support may be maintained for modules corresponding to Gravity. CoherenceFall, Gravity. ILG, Gravity. ILGDerivation, Gravity. GravityParameters, Gravity. Candidates. Podkletnov, Flight. SolidState. VirtualRotor, Flight. GravityBridge, and Applied. OrientationGatedGravity, together with associated theorem or property names such as falling_restores_coherence, coherence_defect_simplify, w_t_ref, w_t_rescale, w_t_nonneg, w_t_ge_one, w_t_formula_grounded, freefall_zero_defect, orientation_gating_viable, and active_stronger_than_idle. Inclusion of such named support is not required to practice the invention, but strengthens the disclosure, preserves narrower fallback support, and reinforces the internal consistency of the disclosed architecture.

Formal verification is therefore used herein as a credibility anchor, an implementation-support tool, and a source of narrower fallback positions. Formal verification is not required for every commercial embodiment and is not presented as the sole basis of physical operability, but it materially strengthens the disclosure of the exact relations, parameter structures, and control logic described herein.

Downstream uses of the invention may include, without limitation, precision gravimetry, inertial sensing, model-validation apparatus, environmental survey tools, wave-detection enhancement tools, propulsion research tools, and shielding research tools. However, such downstream uses remain subordinate to the core inventive mechanism. The identity of the invention is the disclosed gravitational interaction modulation architecture itself, not any particular commercial deployment, not any particular ultimate performance target, and not any downstream scientific or engineering program.

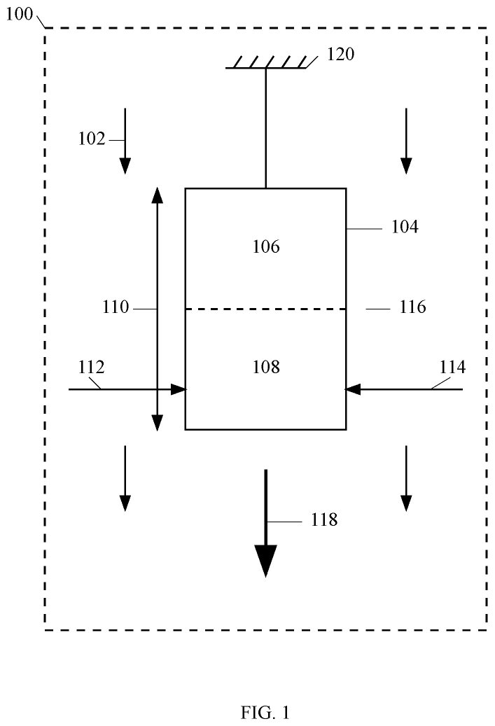

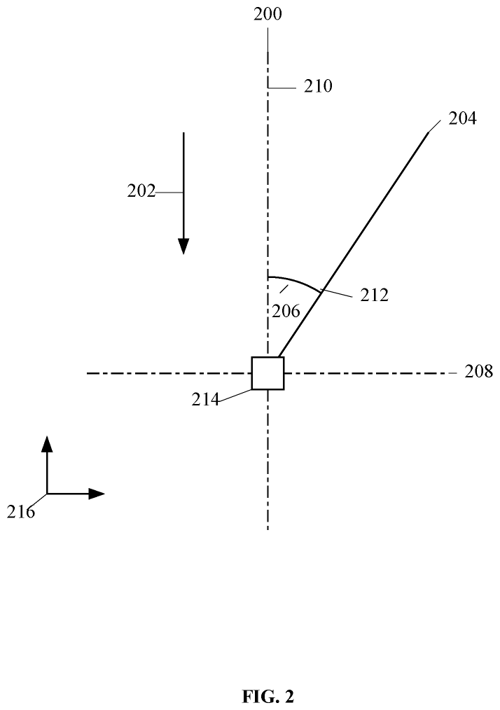

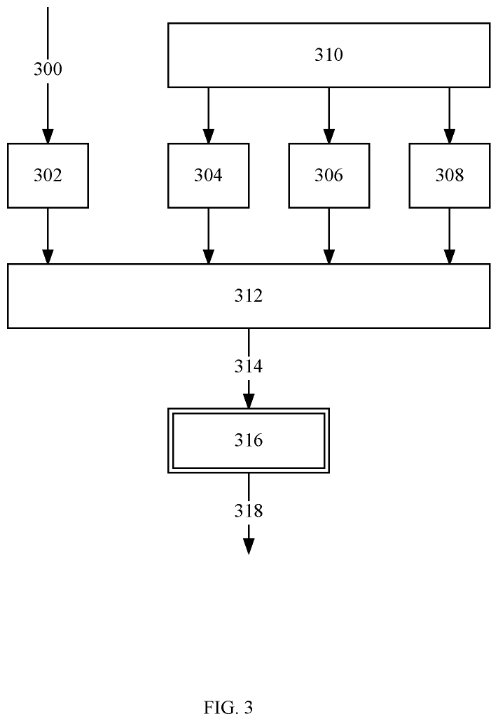

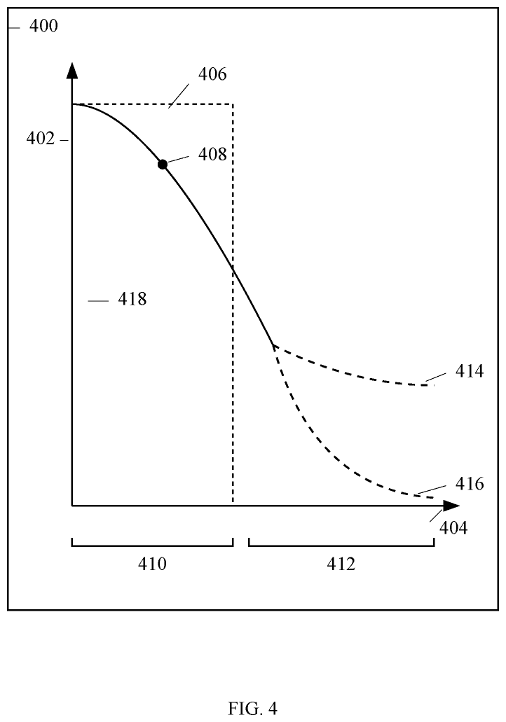

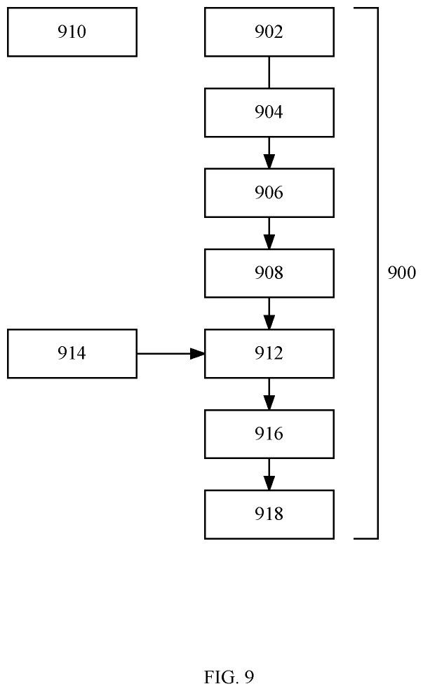

Referring now generally to the drawings, representative figure embodiments are described below in greater detail. FIG. 1 illustrates a coherence-defect view of gravity across an extended object in a local gradient. FIG. 2 illustrates orientation gating through an effective angle relative to the local gradient. FIG. 3 illustrates the combination of orientation weighting, time-kernel weighting, and optional phase gating. FIG. 4 illustrates representative time-kernel behavior versus normalized dynamical timescale. FIGS. 5 through 8 illustrate representative embodiment families. FIGS. 9 through 12 illustrate representative measurement, control, validation, and integrated-system arrangements.

In FIG. 1, a gravitational field region 100 includes a local gravitational gradient 102 acting across an extended object 104 having an upper object portion 106 and a lower object portion 108 separated by an object extent 110. Fast-processing side indicator 112 and slow-processing side indicator 114 denote a gradient-dependent mismatch across the object, thereby defining coherence defect 116. Free-fall acceleration a* 118 represents the unique acceleration restoring zero coherence defect. Restrained-state indicator 120 may represent a supported or non-free-fall operating condition in which a non-zero defect is sustained.

In FIG. 2, gravitational gradient axis 200 and vertical direction arrow 202 define a local reference direction against which interaction channel 204 is oriented. Effective angle theta 206 is the angle between the interaction channel and the local gravitational gradient. Suppressed-coupling orientation 208 corresponds to a weak-coupling state, while full-coupling orientation 210 corresponds to a stronger-coupling state. Orientation weight relation 212 illustrates the preferred sin squared dependence. Device element 214 and local reference frame 216 illustrate that the angle may be defined relative to a concrete structural or modal element.

In FIG. 3, gravitational source input 300 is associated with a base gravitational coupling g_0 302. Orientation-control branch 304 applies an orientation-dependent weighting based on a selected or measured effective angle. Time-kernel-control branch 306 applies a weighting based on the effective dynamical timescale of the device. Optional phase-gating branch 308 applies a timing or duty-cycle weighting corresponding to permitted or selected phase windows. Controller 310 coordinates one or more of these branches and supplies inputs to coupling combiner 312, which produces an effective coupling output g_eff 314 acting on measurement target or test mass 316. Signal output 318 represents a measured or derived modulation signal associated with the resulting effective coupling.

FIG. 3 is useful for understanding that the invention may be implemented as a modular architecture. In some embodiments, controller 310 actively commands the angle state, timescale state, and phase state. In other embodiments, one or more of branches 304, 306, and 308 may be passively defined by physical structure, with controller 310 only selecting among operating regimes or collecting measurement data. In still other embodiments, controller 310 may close one or more feedback loops using measured output 318 so as to maximize sensitivity, reject artifact, or maintain a selected operating point.

In FIG. 4, graph frame 400 includes vertical axis 402 representing the time-kernel weighting term w_t and horizontal axis 404 representing the normalized ratio T_dyn/tau_0. Kernel curve 406 illustrates that the weighting changes as a function of the normalized dynamical timescale. Reference point 408 corresponds to the condition T_dyn equals tau_0, at which the kernel equals unity in the disclosed relation. Fast-dynamics regime 410 represents operation near or toward the reference condition, while slow-dynamics regime 412 represents operation at larger normalized timescales. Constant-C_lag scenario indicator 414 and scale-running scenario indicator 416 illustrate that different theoretical or empirical assumptions may lead to different quantitative response magnitudes, while enhancement region 418 identifies an operating region in which the weighting is increased relative to the reference condition.

FIG. 4 supports several useful experimental and claim-drafting positions. First, it supports the proposition that the effective dynamical timescale is an operationally controllable variable. Second, it supports comparison-based methods in which a modulation response is measured at multiple T_dyn states. Third, it supports validation and falsification methods in which the measured dependence on T_dyn is compared with one or more expected model classes. Accordingly, FIG. 4 may support both apparatus claims and method-of-testing claims.

Referring now to FIG. 5, rotor assembly 500 includes rotor disk 502 provided with phi-spiral arms 504 extending about center hub 506. Rotor disk 502 is supported for rotation about rotation axis 508 and is driven by drive motor 510. Bearing structure 512 may include any suitable low-artifact support arrangement, including mechanical, magnetic, air, fluid, cryogenic, or other bearing structures. Test mass 514 is positioned adjacent rotor disk 502 and is coupled to force sensor 516. Enclosure or shield 518 may include magnetic shielding, electrostatic shielding, vacuum boundaries, vibration-isolation structures, thermal barriers, or combinations thereof.

In operation of the embodiment of FIG. 5, rotation of rotor disk 502 causes the interaction geometry presented to test mass 514 to vary in time. In particular, phi-spiral arms 504 may create a time-varying effective interaction angle at the position of test mass 514, thereby modulating the orientation-dependent weighting term. At the same time, the rotation period or a related rotational timescale defines or contributes to the effective dynamical timescale used in the time-kernel weighting. Thus, a single rotating embodiment may conveniently provide both angle control and timescale control in a physically coupled manner.

In some embodiments of FIG. 5, rotor disk 502 is fabricated from a rigid material such as a metal, ceramic, composite, semiconductor, superconducting material support, or other structurally suitable substrate. In some embodiments, phi-spiral arms 504 are formed as grooves, ridges, channels, field-defining traces, deposited structures, cavities, patterned masses, or other geometric features capable of producing the desired angle-varying interaction profile. In some embodiments, the rotor includes eight arms or equivalent eight-position structures to align with the preferred eight-tick framework, although the broader invention is not limited to a specific arm count unless expressly claimed.

In some forms, test mass 514 is vertically spaced from rotor disk 502. In some forms, test mass 514 is offset laterally, radially, axially, or angularly relative to rotor disk 502 to sample a desired interaction region. In some forms, multiple test masses or multiple force sensors are used. In some forms, force sensor 516 is a torsion-balance element, cantilever sensor, SQUID-coupled sensor, interferometric displacement sensor, capacitive sensor, piezoresistive sensor, or other sensor capable of resolving a force, displacement, acceleration, torque, or equivalent quantity associated with modulation of effective gravitational coupling.

In a representative operating sequence for the embodiment of FIG. 5, the system is initialized, rotor speed is brought to a selected value corresponding to a desired T_dyn, test mass 514 is allowed to settle or is actively stabilized, measurement timing is synchronized to the rotor phase, and the resulting modulation signal is extracted at a selected harmonic or synchronous frequency. In some embodiments, extraction is performed at eight times the rotation frequency. In some embodiments, extraction is performed at another frequency associated with the patterned geometry, phase schedule, duty-cycle schedule, or a selected differential comparison mode.

By way of non-limiting example, a rotor embodiment may employ a disk substrate having a diameter on the order of about 100 mm and a thickness on the order of about 5 mm, with spiral grooves, ridges, channels, or analogous surface structures formed on one or both faces. In one representative implementation, the patterned structure includes eight spiral arms and is rotated over a controllable speed range extending from low-speed calibration operation to high-speed modulation operation. Such dimensions and operating values are illustrative and may be scaled up or down while preserving the disclosed angle-control and timescale-control mechanism.

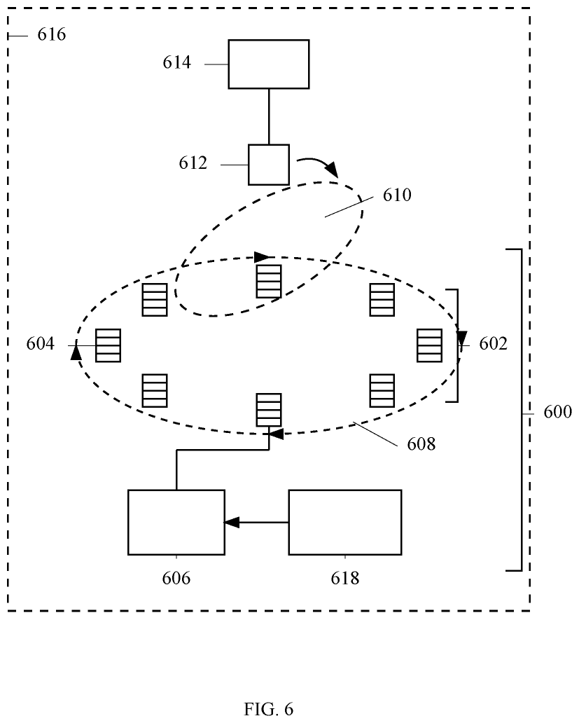

Referring now to FIG. 6, virtual rotor assembly 600 includes coil array 602 made up of individual coils 604 arranged around a selected region. Pulse driver 606 energizes individual coils 604 according to phase sequence path 608 so as to create virtual rotating field 610. Test mass 612 is positioned to interact with the virtual rotating field and is coupled to force sensor 614. Shielding structure 616 provides selected environmental isolation, and timing controller 618 governs pulse sequencing, phase alignment, duty-cycle control, and measurement synchronization.

The embodiment of FIG. 6 does not require continuous physical rotation of a macroscopic rotor. Instead, the effective interaction channel is rotated in a virtual or field-defined manner by time sequencing of actuation elements. This can reduce vibration, eliminate rotating-mass artifacts, permit very high effective field-rotation rates, and provide fine control over timing schedules, including the preferred eight-tick phase structure. In some embodiments, individual coils 604 are electromagnetic coils. In other embodiments, they are electrodes, current paths, field emitters, resonant elements, superconducting structures, or other actuation elements capable of producing the desired effective interaction pattern.

In some forms, phase sequence path 608 is a cyclic sequence through a plurality of actuation positions. In some forms, the sequence is strictly periodic. In some forms, the sequence includes dwell times, weighted pulses, skipped positions, paired positions, mirrored schedules, or phase-gated omissions. In preferred implementations, timing controller 618 enforces an eight-tick-neutral or otherwise eight-tick-synchronized schedule so that the resulting virtual rotating field 610 aligns with the disclosed phase-gating architecture.

In some embodiments of FIG. 6, the effective dynamical timescale is the sequence cycle period, the interval between repeating virtual-rotation states, or another timescale derived from the pulse schedule. In some embodiments, the effective angle is determined from the instantaneous or effective orientation of virtual rotating field 610 relative to the local gravitational gradient. In some embodiments, a plurality of virtual channels are generated simultaneously or quasi-simultaneously, and the net effective coupling is obtained from their combined contribution.

By way of non-limiting example, a phased-array embodiment may employ eight or more actuation elements arranged at equal or substantially equal angular intervals around a selected region, with pulse widths ranging from nanoseconds to microseconds and with timing jitter controlled sufficiently to preserve the desired phase schedule. In representative preferred implementations, the pulse schedule is synchronized to an eight-tick cadence so that sequence coherence, effective virtual rotation, and measurement synchronization are preserved.

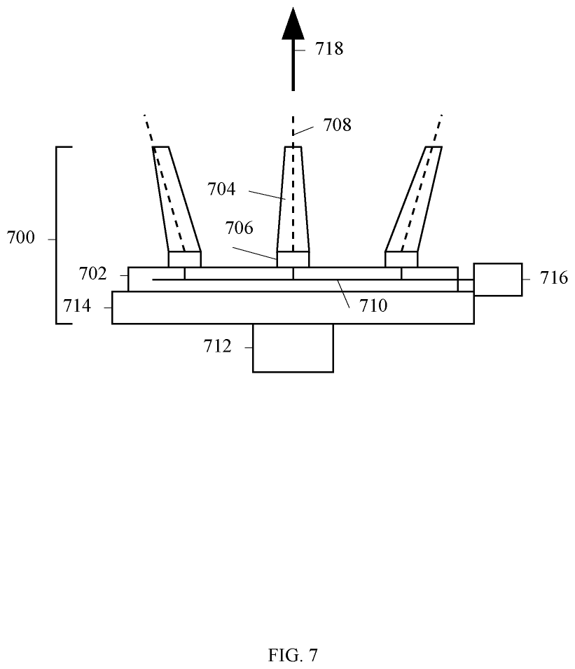

FIG. 7 illustrates cavity-array assembly 700 including substrate 702 carrying asymmetric cavity cells 704. Each cavity cell 704 is mounted on or associated with rotatable stage 706 having per-cell orientation axis 708. Angle-control bus 710 and controller interface 716 allow programmed orientation of each cavity cell or groups of cavity cells. Force sensor 712 is associated with support frame 714, and array net-force direction 718 illustrates a representative aggregate coupling direction arising from the selected cavity orientation pattern.

The embodiment of FIG. 7 is useful because it permits distributed control over interaction-channel angle across many elements. In some forms, all cavity cells 704 are oriented alike. In some forms, different subsets of cavity cells 704 are placed at different angles to implement a weighted distribution of channel states. In some forms, the angle states are static during a measurement window. In some forms, the angle states are swept or toggled dynamically. In some forms, the cavity array is used to compare a suppressed-coupling orientation state with a full-coupling orientation state. In some forms, the array is used to produce a time-varying net effective coupling by coordinated angle motion of the stages.

Although cavity cells 704 may be implemented as asymmetric Casimir cavities in some preferred embodiments, the broader array concept is not limited to one cavity physics model. More generally, cavity cells 704 may include structured cells, resonant cavities, layered cells, field-shaping cavities, asymmetric gap structures, or other angle-definable microstructures or mesostructures capable of presenting a selected effective interaction angle relative to the local gravitational gradient. Similarly, rotatable stage 706 may be implemented by a MEMS structure, piezoelectric actuator, electrostatic actuator, magnetic actuator, mechanical linkage, thermal actuator, or other suitable positioning arrangement.

In some embodiments of FIG. 7, angle-control bus 710 sets a static configuration and force sensor 712 measures a corresponding net force. In some embodiments, angle-control bus 710 drives a periodic angle modulation sequence, and force sensor 712 measures a corresponding synchronous modulation signal. In some embodiments, controller interface 716 commands different angle-distribution patterns to produce enhancement-mode, suppression-mode, or differential-comparison operation. In some embodiments, cavity-array assembly 700 is combined with a separate timescale-control subsystem, while in other embodiments the cavity actuation schedule itself contributes to the effective dynamical timescale.

By way of non-limiting example, a cavity-array embodiment may employ an array of asymmetric cavities having characteristic lateral dimensions on the order of hundreds of micrometers and characteristic gap dimensions on the order of tens of nanometers, with individual or grouped rotary stages capable of setting cavity angle states with sub-degree precision. Such dimensions are illustrative only and are provided as representative make-and-use support for an angle-programmable cavity-array platform.

In some optional embodiments, a cavity-based orientation-control array may be integrated with one or more energy-harvesting, resonant, or auxiliary power-support structures, provided that such auxiliary structures do not alter the core identity of the invention as a gravitational interaction modulation architecture based on angle control and timescale control. Such integrations are optional and may support packaging, deployment, or subsystem efficiency in selected implementations.

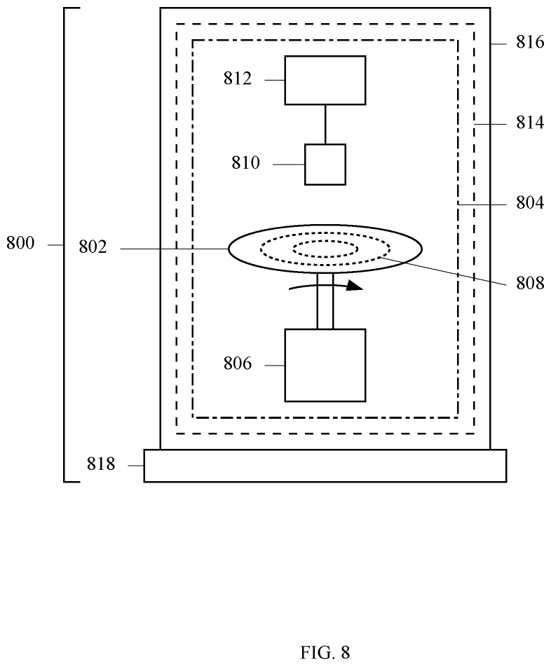

Turning now to FIG. 8, superconducting modulator 800 includes superconducting disk 802 disposed within cryostat 804 and driven by rotational drive 806. Surface patterning 808 is provided on the disk, such as by grooves, traces, ridges, deposited regions, mass-distribution features, or other geometric patterning. Test mass 810 is positioned relative to the rotating disk and is coupled to cryogenic force sensor 812. Magnetic shield 814, vacuum boundary 816, and support structure 818 cooperate to control the operating environment and reduce non-gravitational artifacts.

In some embodiments, superconducting disk 802 is fabricated from a high-temperature superconducting material. In some embodiments, superconducting disk 802 includes c-axis texture or another anisotropic internal structure. In some embodiments, surface patterning 808 is selected to provide a phi-spiral or otherwise angle-varying interaction geometry so that rotation of disk 802 produces a time-varying effective interaction angle at the location of test mass 810. In some embodiments, rotational drive 806 is magnetic, eddy-current based, mechanically coupled, fluid-coupled, or otherwise suitable for controlled cryogenic operation.

The embodiment of FIG. 8 can be used to explore whether a superconducting platform changes sensitivity, background, or implementation efficiency under the disclosed architecture. However, the superconducting platform is not the invention itself. Rather, it is one preferred embodiment family for implementing the same core angle-plus-timescale control mechanism described herein. Accordingly, the present disclosure should not be interpreted as requiring superconductivity unless expressly stated in a claim.

In some operating protocols for the embodiment of FIG. 8, measurements are made at multiple rotation speeds, multiple environmental states, or multiple test-mass compositions. Material-independence checks may be performed by replacing test mass 810 with bodies of different materials while preserving geometry or overall measurement conditions as closely as practicable. Vacuum-persistence checks may be performed by changing pressure conditions across vacuum boundary 816. Thermal-persistence or cryogenic-state checks may be performed by varying temperature or superconducting state while holding other variables fixed to the extent possible.

By way of non-limiting example, a superconducting embodiment may employ a disk structure having a diameter on the order of about 300 mm and a thickness on the order of about 10 mm, rotated over a controlled speed range extending up to several thousand revolutions per minute, and maintained within a cryogenic environment such as a liquid-nitrogen or lower-temperature system. In representative implementations, patterned surface structures and environmental controls are selected so that any observed modulation signal can be tested for material independence, vacuum persistence, thermal persistence, and speed-family behavior.

Representative non-limiting numerical examples further illustrate the disclosed architecture. In one example, a rotating embodiment operating at about 5000 revolutions per minute may have an effective dynamical timescale T_dyn on the order of about 12 milliseconds. Under a theory-supported reference reporting convention in which tau_0 is on the order of about 7.3×10^−15 seconds, the normalized ratio T_dyn/tau_0 is on the order of about 10^12, and the corresponding kernel factor may be estimated for selected model assumptions. In a constant-C_lag theory-supported scenario, the resulting kernel weighting may be large; in a scale-running scenario, the resulting kernel weighting may instead fall in a small-increment regime. These example calculations are illustrative and are included to show representative operating envelopes, model discrimination paths, and expected signal classes, not to limit the invention to any one predicted magnitude.

In a further representative example, a phased-array or virtual-rotor embodiment may operate at an effective sequence period in the nanosecond to microsecond range, producing a different normalized T_dyn/tau_0 ratio and correspondingly different time-kernel values under the same or different model assumptions. In another representative example, a combined angle-and-timescale modulation may produce a measurable signal class in the parts-per-billion or higher regime depending on selected geometry, sensing sensitivity, synchronization quality, environmental control, and whether a constant-kernel or scale-running-kernel interpretation is assumed. Such examples strengthen the practical make-and-use disclosure and support the validation workflows described herein.

Referring now to FIG. 9, measurement system 900 includes test mass 902, force sensor 904, preamplifier 906, lock-in amplifier 908, calibration mass subsystem 910, data-acquisition unit 912, environmental sensor package 914, analysis processor 916, and output display or log 918. Measurement system 900 is intended to provide a structured pathway from raw coupling response to an extracted modulation signal.

In one representative implementation, test mass 902 is mechanically or otherwise coupled to force sensor 904. Force sensor 904 produces an electrical, optical, magnetic, interferometric, capacitive, or other signal proportional to a force, displacement, acceleration, or related quantity. Preamplifier 906 conditions this signal, and lock-in amplifier 908 extracts the component synchronous with a selected modulation reference. Calibration mass subsystem 910 permits known gravitational or pseudo-gravitational calibration steps. Data-acquisition unit 912 records raw or partially processed data. Environmental sensor package 914 records temperature, pressure, vibration, magnetic field, acoustic state, timing state, or similar environmental variables. Analysis processor 916 processes the collected data, and output display or log 918 presents results.

In some embodiments, lock-in amplifier 908 uses a reference frequency derived from rotor phase, pulse sequence timing, cavity angle schedule, or another synchronous event train. In some embodiments, multiple reference frequencies or harmonics are used. In some embodiments, a null or background reference is simultaneously recorded. In some embodiments, analysis processor 916 computes a differential signal by comparing an active state to an inactive or alternative-angle state. In some embodiments, analysis processor 916 fits the extracted signal to one or more model classes, including angle-law or timescale-law models.

Calibration mass subsystem 910 may include one or more known source masses on precision stages, a known force standard, a test fixture, a positioner, or another calibration arrangement. In some embodiments, calibration is performed before each measurement sequence. In some embodiments, calibration is periodically refreshed. In some embodiments, calibration is used to establish sensitivity, check drift, verify directionality, or validate one or more angle states. In some embodiments, calibration mass subsystem 910 is omitted and the system is calibrated by another accepted procedure.

In representative preferred implementations, force sensing may be carried out using a cryogenic torsion-balance or SQUID-coupled system having sub-femto-Newton sensitivity, or using a room-temperature balance or cantilever system having nano-Newton or finer sensitivity depending on the target regime and embodiment. These values are illustrative of achievable measurement classes and are not limiting. The important point is that the sensing architecture is selected to resolve the expected modulation signal at the chosen operating frequency and under the chosen environmental conditions.

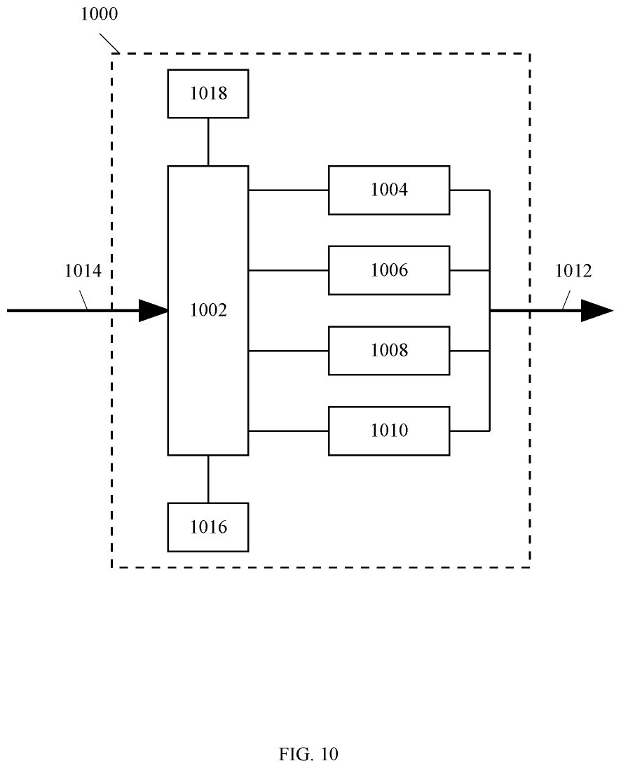

Turning now to FIG. 10, controller system 1000 includes main controller 1002, speed-control loop 1004, angle-control loop 1006, phase-control loop 1008, null or artifact-cancellation loop 1010, actuator output bus 1012, sensor input bus 1014, storage or logging module 1016, and user interface 1018. Controller system 1000 may be implemented using any suitable combination of digital logic, programmable logic, processors, timing hardware, firmware, software, analog circuitry, or mixed-signal circuitry.

In some embodiments, main controller 1002 receives operator commands or automated operating profiles through user interface 1018 and stores settings, logs, or result packets in storage module 1016. Sensor input bus 1014 receives signals from one or more measurement sensors, environmental sensors, timing references, encoder structures, or calibration subsystems. Actuator output bus 1012 sends commands to one or more motors, pulse drivers, rotatable stages, timing generators, field emitters, or synchronization systems.

Speed-control loop 1004 maintains a selected rotation rate, sequence rate, oscillation rate, or other parameter corresponding to the desired effective dynamical timescale. Angle-control loop 1006 maintains a selected orientation state or angle schedule for one or more interaction channels. Phase-control loop 1008 maintains a selected phase mask, permitted-window schedule, or synchronization relationship. Null or artifact-cancellation loop 1010 may be used to suppress vibration, compensate background drift, reject non-synchronous disturbances, or drive the system through null states used for comparison measurements.

In a representative workflow, main controller 1002 initializes the system, verifies readiness, performs or requests calibration, sets a desired operating mode, commands speed-control loop 1004 and angle-control loop 1006 to achieve a target T_dyn and a target theta profile, optionally applies a phase schedule using phase-control loop 1008, acquires measurement data, extracts a modulation signal, compares the signal against one or more thresholds or acceptance criteria, and either records an accepted result or repeats, rejects, or refines the run. Such control logic is supportive of make-and-use enablement but is not itself the core inventive identity.

In some embodiments, the controller further executes an auto-calibration workflow in which one or more effective-angle states are swept through a selected range, one or more timescale states are stepped or swept through a selected range, and the resulting measured responses are compared to a stored response model, calibration table, or acceptance-criteria set. Such an auto-calibration workflow may be used to verify angle dependence, establish measurement sensitivity, identify an operating point of increased contrast, reject drift, classify environmental state, or prepare the system for subsequent active modulation runs.

In some embodiments, the controller further includes a watchdog or safeguard function configured to monitor one or more internal state variables, environmental variables, timing-coherence variables, or local cost or defect indicators, and to modify, pause, or disconnect actuation if a selected threshold is exceeded. In one representative fallback form, the safeguard function may monitor a local neutrality, imbalance, or cost-related condition associated with the operating state of the modulator and may suspend modulation when the monitored condition exceeds a selected threshold. Such watchdog logic is optional and subordinate to the core modulation architecture, but provides useful implementation support and narrower fallback positions.

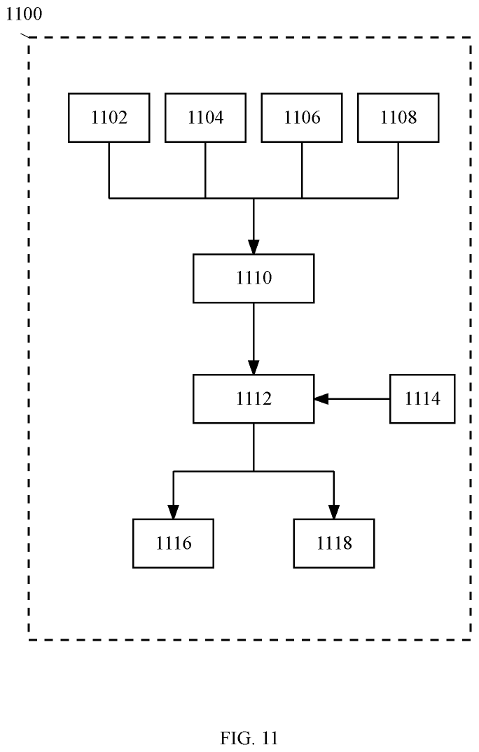

FIG. 11 illustrates validation workflow 1100. Orientation-sweep stage 1102 evaluates whether a measured signal follows a predicted orientation dependence. Frequency-sweep stage 1104 evaluates whether the signal appears at an expected synchronous frequency or harmonic. Material-comparison stage 1106 evaluates whether the signal changes with test-mass material beyond a selected tolerance. Vacuum-and-thermal-control stage 1108 evaluates whether the signal persists under environmental control. Model-fit engine 1110 compares the measured data with one or more candidate models. Result classifier 1112 applies acceptance criteria set 1114 and produces either falsification output 1116 or confirmation output 1118.

Validation workflow 1100 is useful not only scientifically but also structurally in the patent disclosure because it shows that the invention is not a vague aspiration. Rather, the invention provides explicit make-and-use and test-and-evaluate procedures. For example, if no orientation dependence is observed at orientation-sweep stage 1102, that result is informative and may count against the disclosed angle-gating mechanism under the tested conditions. Similarly, if no synchronous frequency response is observed at frequency-sweep stage 1104, that result may count against the tested modulation schedule. The disclosure therefore preserves both operational and falsification discipline.

In some embodiments, acceptance criteria set 1114 includes one or more thresholds for signal-to-noise ratio, phase coherence, repeatability, vacuum persistence, environmental stability, material independence, fit residual, or confidence intervals. In some embodiments, result classifier 1112 uses a deterministic pass/fail logic. In some embodiments, result classifier 1112 ranks operating states by confidence or usefulness. In some embodiments, result classifier 1112 drives controller refinement by identifying improved angle states, timescale states, or phase states for a subsequent run.

Representative falsification outcomes for the disclosed modulation architecture include, without limitation: absence of a measurable dependence on the effective interaction angle; absence of a measurable response at an expected synchronous modulation frequency or harmonic; a material dependence inconsistent with the intended gravitational-coupling interpretation under the tested regime; failure of measured response to follow the expected dependence on effective dynamical timescale; or disappearance of the measured effect under vacuum, cryogenic, or other environmental controls indicative of non-gravitational artifact. These falsification outcomes are useful both scientifically and structurally, because they define explicit conditions under which the disclosed operating model would be disfavored.

In one non-limiting acceptance example, a modulation run is accepted when: (i) a lock-in extracted amplitude at a selected synchronous frequency exceeds a threshold of at least 5× the noise-floor standard deviation measured in a null state; (ii) phase coherence relative to the reference signal exceeds 0.8 over an integration window of at least N cycles; and (iii) repeatability across M repeated runs at the same settings yields a coefficient of variation below 10%. Values of N and M may be selected based on the embodiment bandwidth and the desired confidence level.

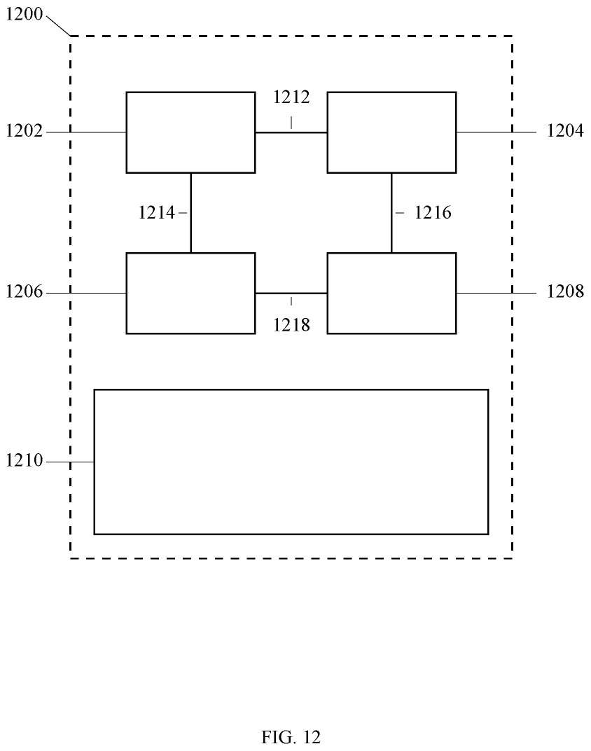

FIG. 12 illustrates integrated modulation platform 1200 including modulator 1202, test mass 1204, sensing subsystem 1206, controller subsystem 1208, calibration subsystem 1210, shielding or enclosure 1212, environmental control subsystem 1214, output terminal 1216, and support base 1218. Integrated modulation platform 1200 is intended to show a complete practical installation rather than a single isolated component.

In some forms, modulator 1202 is one of the previously described rotor, virtual-rotor, cavity-array, or superconducting embodiments. In some forms, sensing subsystem 1206 corresponds to the measurement system of FIG. 9. In some forms, controller subsystem 1208 corresponds to the controller system of FIG. 10. In some forms, calibration subsystem 1210 includes one or more calibration masses, reference actuators, or self-check structures. Shielding or enclosure 1212 may include vacuum walls, magnetic shields, Faraday shielding, acoustic isolation, or thermal isolation. Environmental control subsystem 1214 may include temperature control, vibration control, pressure control, cryogenic control, humidity control, magnetic bias control, or timing stabilization. Output terminal 1216 may provide live data, stored logs, model-fit results, or classification outputs.

The integrated arrangement of FIG. 12 demonstrates that the disclosed invention supports not only a conceptual modulation relation but also a complete physical system architecture. Such an integrated arrangement may be configured for laboratory testing, field deployment, calibration, gravimetric measurement, controller development, or validation studies. Nevertheless, the integrated platform remains an implementation of the core architecture rather than a separate invention.

Returning now to the disclosed core mechanism, in a first family of operating methods, the effective angle is changed while the effective dynamical timescale is held substantially fixed. This can be accomplished by rotating a channel-defining structure, steering an internal mode axis, reorienting one or more cavity elements, or stepping through a programmed sequence of field-defined directions. The resulting change in w_orient can be measured directly or inferred from a measured change in gravitational coupling response.

In a second family of operating methods, the effective dynamical timescale is changed while the effective angle is held substantially fixed. This can be accomplished by changing rotation speed, sequence frequency, pulse repetition rate, oscillation rate, or another control variable governing T_dyn. The resulting change in w_t can be measured directly or inferred from a measured change in gravitational coupling response.

In a third family of operating methods, both effective angle and effective dynamical timescale are changed. The changes may be coordinated to maximize enhancement, maximize suppression, maximize differential contrast between two operating states, or produce a periodic or quasi-periodic signature convenient for synchronized measurement. In preferred forms, an eight-tick phase gate is additionally applied to improve temporal selectivity and signal extraction.

In some embodiments, the modulation method includes an enhancement sequence in which T_dyn is selected to produce a relatively high time-kernel weight while theta is selected to produce a relatively high orientation weight. In some embodiments, the method includes a suppression sequence in which theta is selected to produce a relatively low orientation weight and T_dyn is selected toward a reference or lower-weight state. In some embodiments, enhancement and suppression states are alternated to create a differential measurement protocol.

In some embodiments, the modulation method includes an oscillatory sequence in which one or more of the angle, timescale, and phase variables vary periodically. For example, a rotating embodiment may naturally produce a periodic angle variation while the rotation period defines T_dyn. In a phased-array embodiment, both virtual angle and sequence period may vary in a programmed schedule. In a cavity-array embodiment, selected groups of cavities may alternate between angle states to produce a time-varying net coupling.

The disclosed architecture also supports static comparisons. For example, one run may be performed with a strong-coupling angle configuration and another run may be performed with a weak-coupling angle configuration, while other conditions are held substantially constant. Similarly, one run may be performed at one T_dyn value and another run at a different T_dyn value. By differencing the resulting measured outputs, a modulation signal can be extracted even when absolute background forces are large relative to the incremental change.

In some embodiments, the invention includes refinement logic or optimization logic. Such logic may search through candidate angle states, timescale states, or phase schedules to locate an operating point that increases measured signal, reduces environmental sensitivity, improves repeatability, or better fits a target theoretical profile. Such refinement may be manual, automated, open loop, closed loop, one-time, periodic, or adaptive over the lifetime of the system.

In some embodiments, the system records a result packet for each run, including one or more commanded variables, one or more measured variables, one or more environmental variables, and one or more pass/fail or fit-quality values. In some embodiments, these result packets are used to build a calibration library, a model-fit database, or an operating envelope. In some embodiments, result packets are used to compare constant-kernel and scale-running-kernel scenarios. In some embodiments, result packets are used to support later claim differentiation, continuation practice, or technical refinement.

In some embodiments, recorded result packets are further used to discriminate among alternative kernel-scaling models, including a model in which C_lag is treated as substantially constant over a selected operating regime and a model in which C_lag is treated as scale-dependent or running over that regime. By comparing measured angle-dependent and timescale-dependent response data to multiple candidate models, the disclosed architecture supports not only modulation operation but also structured model discrimination and validation.

Although the disclosure has described certain theory-supported values and exact relations, not every claim need recite all such values or relations. The broadest implementations may rely operationally on angle control and timescale control whether or not a given user invokes the full disclosed theory basis in operation. At the same time, the exact relations disclosed herein, including the coherence-defect framing, the free-fall restoration condition, the time-kernel form, the sin squared orientation law, the preferred eight-tick phase structure, and associated parameter values, provide strategically important fallback support and should be understood as central disclosed features of the specification.

Likewise, although four preferred embodiment families have been described in detail, the invention is not limited to those exact implementations. Other analogous structures can be used, provided that they concretely realize the same disclosed architectural control variables and do not depart from the identity of the invention. At the same time, this disclosure does not claim every possible gravitational-modulation mechanism. Rather, equivalents should be understood as structures analogous to the disclosed actuation and measurement families that preserve the core architecture of orientation-dependent weighting, timescale-dependent weighting, and, in preferred forms, phase-gated timing.

In some embodiments, the invention is used as a precision gravimetry platform. In some embodiments, the invention is used as a validation platform for comparing alternative gravitational-weighting models. In some embodiments, the invention is used in inertial-sensing or navigation contexts. In some embodiments, the invention is investigated for propulsion or shielding research. These applications may benefit from the disclosed architecture, but they remain applications of the core modulator rather than redefining the invention itself.

In some embodiments, the disclosed architecture is configured for precision gravimetry, including geophysical survey, underground-feature detection, or environmental field mapping. In some embodiments, the architecture is configured for inertial sensing or navigation in GPS-denied environments. In some embodiments, the architecture is configured as a platform for testing gravitational-model predictions, including comparison of angle-law and timescale-law behaviors under controlled conditions. In some embodiments, the architecture is investigated for propulsion research, shielding research, or wave-detection enhancement. In all such cases, the downstream use remains subordinate to the disclosed modulation architecture itself.

The present invention therefore provides a disciplined, filing-ready disclosure of a gravitational interaction modulation architecture that is broad enough to preserve multiple embodiment pathways and fallback claim positions, but specific enough to preserve a clear and defensible statement of the core invention. The invention remains centered on modulating effective gravitational coupling by coordinated control of effective interaction angle and effective dynamical timescale, optionally further coordinated with an eight-tick phase-gating framework.

While the invention has been described with reference to representative embodiments, modes, figures, and workflows, those skilled in the art will recognize that variations, substitutions, rearrangements, and refinements can be made without departing from the scope of the invention as defined by the claims. Accordingly, the foregoing detailed description is to be regarded as illustrative rather than limiting.

What is claimed is:

1. A method of modulating effective gravitational coupling between a device and a gravitational source, comprising:
providing a device having at least one effective interaction channel characterized by an effective angle theta relative to a local gravitational gradient;
controlling the effective angle theta to vary an orientation-dependent coupling weight;
controlling an effective dynamical timescale Tdyn of the device to vary an information-limited gravity time-kernel weight; and
measuring a resulting change in gravitational force, acceleration, or equivalent coupling response on a test mass or other measurement target.

2. The method of claim 1, wherein the orientation-dependent coupling weight is proportional to the square of the sine of theta.

3. The method of claim 1, wherein the information-limited gravity time-kernel weight is based on:
(i) a ratio of Tdyn to a reference recognition tick tau0;
(ii) an exponent alpha_t applied to said ratio; and
(iii) a lag-coupling coefficient Clag that scales a deviation of the time-kernel weight from a reference value of one when Tdyn equals tau0.

4. The method of claim 3, wherein:
(a) Clag is based on phi raised to a negative fifth power; and
(b) alpha_t is based on one minus the reciprocal of phi, divided by two, where phi is the golden ratio.

5. The method of claim 1, further comprising applying an eight-tick phase gate to permit, suppress, or weight gravitational interaction events according to phase position within an eight-tick cadence.

6. The method of claim 1, wherein the device comprises a plurality of effective interaction channels having respective effective angles, and wherein effective gravitational coupling is determined from a combined contribution of the plurality of effective interaction channels.

7. The method of claim 1, wherein controlling the effective dynamical timescale comprises changing a rotation period, an oscillation period, a modulation period, a pulse repetition schedule, or a field-sequencing schedule.

8. The method of claim 1, wherein controlling the effective angle theta comprises rotating a physical structure relative to the local gravitational gradient.

9. The method of claim 8, wherein the physical structure comprises a rotor having a phi-spiral surface geometry.

10. The method of claim 1, further comprising extracting a modulation signal using synchronized detection or lock-in detection at a modulation frequency associated with angle variation, phase gating, or an effective rotational sequence.

11. A gravitational modulation apparatus comprising:
an orientation-control structure configured to define or vary an effective interaction-channel angle relative to a local gravitational gradient;
a timescale-control structure configured to set or vary an effective dynamical timescale T_dyn;
a controller configured to coordinate angle control and timescale control; and
a measurement structure configured to detect a corresponding modulation in effective gravitational coupling.

12. The apparatus of claim 11, further comprising a phase-control structure configured to gate interaction events according to an eight-tick cadence.

13. The apparatus of claim 11, wherein the orientation-control structure comprises a rotatable structure having a phi-spiral surface pattern.

14. The apparatus of claim 11, wherein the orientation-control structure comprises a phased array of actuation elements configured to generate a virtual rotating interaction structure without continuous physical rotation.

15. The apparatus of claim 11, wherein the orientation-control structure comprises an array of cavities or structured cells mounted on individually or collectively controllable stages.

16. The apparatus of claim 11, wherein the apparatus comprises a superconducting structure configured for rotation or dynamic driving under controlled environmental conditions.

17. The apparatus of claim 11, wherein the measurement structure comprises a torsion balance, a SQUID-coupled sensor, a cantilever sensor, an interferometric sensor, a capacitive sensor, or a piezoresistive sensor.

18. A non-transitory computer-readable medium storing instructions that, when executed by a controller, cause the controller to:
compute an information-limited gravity time-kernel weight for a current effective dynamical timescale Tdyn; compute an orientation-dependent coupling weight for one or more effective interaction channels based on an effective angle theta; compute an effective gravitational coupling from the time-kernel weight and the orientation-dependent coupling weight; and command one or more actuators to set a desired effective dynamical timescale Tdyn and a desired effective interaction-angle state.

19. The non-transitory computer-readable medium of claim 18, wherein the instructions further cause the controller to apply an eight-tick phase schedule and to synchronize measurement to a modulation frequency associated with angle variation, phase gating, or an effective rotational sequence.

20. The non-transitory computer-readable medium of claim 18, wherein the instructions further cause the controller to perform one or more of calibration, background subtraction, angle sweeps, timescale sweeps, material comparisons, vacuum-persistence checks, and comparison of measured results to one or more acceptance criteria.
